(19) United States
(12) Patent Application Publication
(10) Pub. No.: US 2026/0208379 A1
(43) Pub. Date: Jul. 23, 2026

(54) FOOD PRODUCT SLICER AND ASSOCIATED KNIFE REMOVAL TOOL, AND SYSTEM INCLUDING THE SLICER AND THE TOOL

(71) Applicant: ILLINOIS TOOL WORKS INC., Glenview, IL (US)

(72) Inventors: Matthew W. BIRD, Xenia, OH (US); Jeffrey H. STACHOWSKI, Dayton, OH (US); Austin RUTLEDGE, Troy, OH (US); Sumuk MANJUNAATH, Dayton, OH (US); Fadi ABIMOSLEH, Springboro, OH (US)

(21) Appl. No.: 19/443,551

(22) Filed: Jan. 8, 2026

Related U.S. Application Data
(60) Provisional application No. 63/748,208, filed on Jan. 22, 2025.
(60) Provisional application No. 63/868,808, filed on Aug. 22, 2025.

(51) Int. Cl. B26D 7/22; B26D 7/26

(52) U.S. Cl. CPC B26D 7/225; B26D 7/2621; B26D 2210/02

(57) ABSTRACT

A system includes a food product slicer that includes: a base; a knife mounted for rotation about an axis relative to the base via a knife drive shaft; the knife drive shaft includes an end portion that overlaps an externally facing surface portion of the knife to hold the knife, and a biasing mechanism pressing the knife toward an underside of the end portion. A knife removal tool is configured for engaging with the knife drive shaft and the knife so as to remove the knife from the knife drive shaft. The knife removal tool is configured to: enable removal of the knife from the knife drive shaft (i) irrespective of a rotational position of the knife removal tool relative to any fixed portion of the food product slicer; and/or (ii) irrespective of a rotational position of the knife relative to any fixed portion of the food product slicer.

### TECHNICAL FIELD

This application relates generally to food product slicers of the type commonly used to slice bulk food products and, more specifically, to a food product slicer with a rotatable slicer knife and a knife removal tool for use with the same.

### BACKGROUND

Typical reciprocating food slicers have a rotatable, circular or disc-like slicing blade, an adjustable gauge plate for varying the thickness of the slice and a carriage for supporting the food product as it is moved back and forth past the cutting edge of the knife, and over a knife cover plate, during slicing. A drive motor may be linked to drive the carriage back and forth during an automatic slicing operation carried out by a controller of the slicer. The gauge plate is situated along the edge of the knife toward the front of a slicing stroke and is laterally movable with respect to the knife for varying the thickness of the slices to be cut. A rotatable adjustment or indexing knob is provided for manually varying a spacing between the plane of the gauge plate surface and the plane of the knife edge for the purpose of slicing, so that operators can select a thickness of slices to be produced.

Slicer knife tools for removal of the slicer knife while protecting the slicer knife edge from damage are known. For example, U.S. Pat. No. 8,136,435 discloses one such tool. Existing knife removal systems, such as that of the above-mentioned patent, necessitate all the parts (knife, removal tool, and knife drive shaft) to be located at one position. Existing systems are not intuitive as to what positioning needs to be achieved for removal or reinstallation of the knife. Existing systems commonly require locating the tool on fixed portions of the slicer, such as the ring guard. This locating of the parts is necessary to position the removal tool against solid surfaces that prevent rotation. Pinning the removal tool against solid surfaces on the outside diameter helps give additional leverage to overcome a powerful spring.

Providing a tool that (i) more securely holds the slicer knife against improper removal by slicer operators, (ii) provides better knife cleanability and/or (iii) is more intuitive for the user, are also desirable goals.

It would be desirable to provide a slicer system, and associated slicer knife removal tool, that improves upon the existing systems and tools.

### SUMMARY

In one aspect, a system includes a food product slicer and a knife removal tool. The food product slicer includes: a base; a knife mounted for rotation about an axis relative to the base via a knife drive shaft; wherein the knife drive shaft includes an end portion that overlaps an externally facing surface portion of the knife to hold the knife, and a biasing mechanism pressing the knife toward an underside of the end portion. A knife removal tool is configured for engaging with the knife drive shaft and the knife so as to remove the knife from the knife drive shaft, wherein the knife removal tool is configured to: (i) enable removal of the knife from the knife drive shaft irrespective of a rotational position of the knife removal tool relative to any fixed portion of the food product slicer; and/or (ii) enable removal of the knife from the knife drive shaft irrespective of a rotational position of the knife relative to any fixed portion of the food product slicer.

In another aspect, a slicer knife system includes a knife removal tool, and a disc-shaped slicer knife engaged with the knife removal tool. The knife removal tool includes at least one locking component that must be moved to an unlock position to allow a handle of the knife removal tool to rotate and release the slicer knife, wherein the locking component is configured to prevent an operator from moving the locking component to the unlock position without a tool.

In a further aspect, a slicer knife removal tool includes a tool circular body with an outer peripheral edge, wherein the tool body includes a set of through openings located near the outer peripheral edge and distributed around a periphery defined by the peripheral edge so as to facilitate cleaning of a knife engaged with the tool body. The set of through openings are sized and positioned such that a knife cutting edge is not fully exposed.

In another aspect, a food product slicer includes a base; a knife mounted for rotation about an axis relative to the base via a knife drive shaft; wherein the knife drive shaft includes an end portion that overlaps and externally facing surface portion of the knife to hold the knife, and a biasing mechanism pressing the knife toward an underside of the end portion.

In another aspect, a slicer knife removal tool includes a body portion for receiving the knife and protecting a peripheral cutting edge of the knife; a rotatable assembly positioned within a central opening of the body portion; and an assembly lock that interacts with the rotatable assembly to hold the rotatable assembly in either a knife retaining/holding position relative to the body portion or a knife release position relative to the body portion.

In yet another aspect, an assembly includes a slicer knife and a knife removal tool holding the slicer knife, where the knife removal tool includes: a body portion that receives the slicer knife and that is configured to protect a peripheral cutting edge of the slicer knife; a movable assembly configured for movement to a release position that enables the slicer knife to be released from the body portion; and a lock feature movable from a lock position that prevents the movable assembly from moving to the release position and an unlock position that allows the movable assembly to move to the release position, wherein the lock feature must be rotated to move from the lock position to the unlock position.

The details of one or more embodiments are set forth in the accompanying drawings and the description below. Other features, objects, and advantages will be apparent from the description and drawings, and from the claims.

### BRIEF DESCRIPTION OF DRAWINGS

FIGS. 1-4 show perspective views of a food product slicer;

FIGS. 5-23 show various features of one embodiment of the slicer and removal tool;

FIGS. 24-34 and 38 show various features of another embodiment of the slicer and removal tool; and

FIGS. 35-37 depict slicer production with and without a cover associated with the knife retaining components of the slicer.

### DETAILED DESCRIPTION

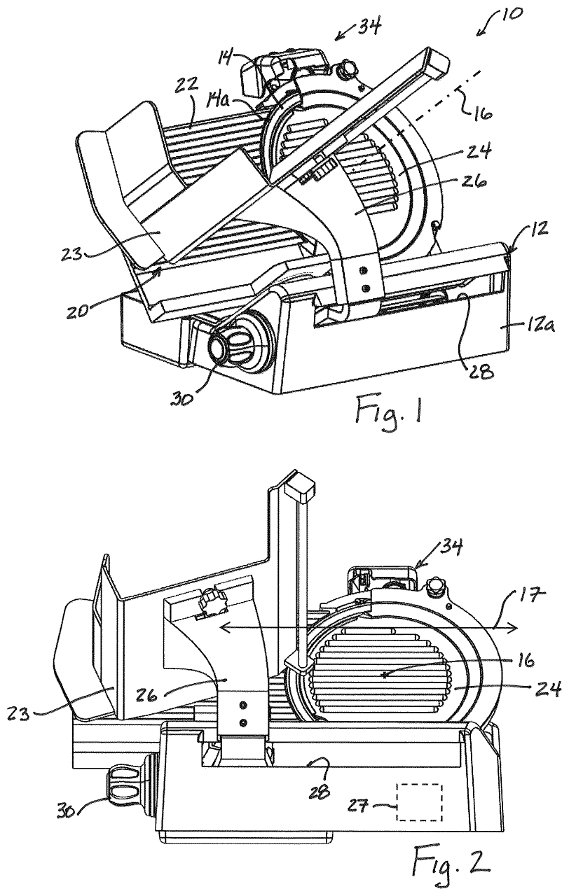

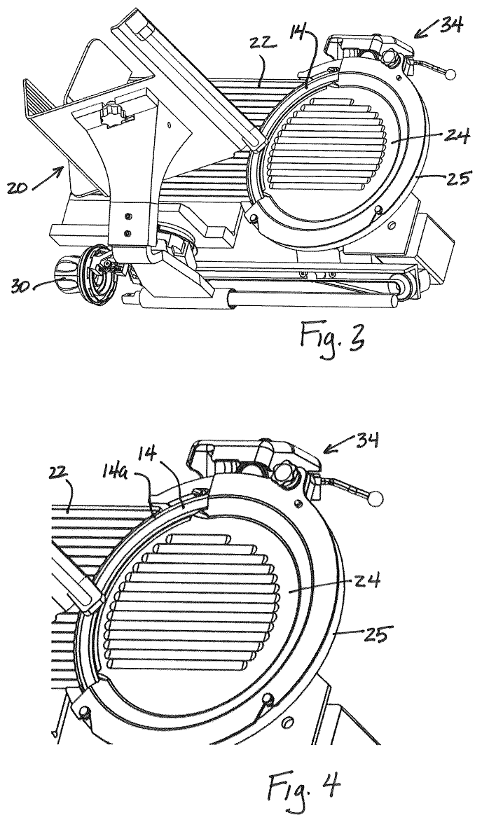

Referring to FIGS. 1-4, a food product slicer 10 includes a base 12 (e.g., housing and/or frame) and a circular, motor-driven slicing knife 14 that is mounted to the housing for rotation about an axis 16. The left side of FIG. 2, where the controls are located and an operator is located during slicing, is generally referred to as the front side of the slicer (which is where an operator stands for slicing), and the right side of FIG. 1 is generally referred to as the rear side of the slicer. A food product can be supported on a manually operable (or motor driven) food carriage 20 which moves the food product to be sliced past the cutting edge 14a of the rotating slicing knife 14. The food carriage 20 reciprocates back and forth along a linear path 17 so that the lower end of the bulk food product slides along the surface of a gauge plate 22, is cut by the knife 14 and then slides along a knife cover plate 24 which mounts to a ring guard 25. The food carriage 20 includes a tray 23 mounted on a tray arm 26 that orients the food carriage tray at the appropriate angle (typically perpendicular) to the knife cutting-edge plane. The food carriage arm reciprocates along a slot 28 at a lower portion of an external housing 12a of the base 12. The carriage 20 can be moved manually (e.g., by a handle) and/or the carriage 20 may also be automatically driven (e.g., as by an internal motor 27 that drives a belt that is linked internally to the arm). A gauge plate system includes a rotatable knob 30 (connected to an opening in the base 12). Rotation of the knob 30 effects movement the gauge plate, relative to a plane of the knife edge 14a, to adjust slice thickness. A knife sharpener assembly 34 may be mounted on the machine and can be manually operated to sharpen the knife edge 14a.

### First Embodiment

The knife shaft mount and tool system design described herein removes the need for locating the removal tool on the ring guard. This is done, in part, by providing a handle that the operator holds to keep the tool stationary, or to control positioning of the tool, during knife removal and or installation.

To allow the spring force to be reduced, the knife is captured (as opposed to being overhung) to apply an even force on the knife to ensure it is held stably. This design keeps axial and radial runout to a minimum but still allows the spring force to be readily overcome.

Additionally, the need to locate the blade to the ring guard is eliminated, such that only the removal tool needs to be lined up with the blade during knife removal and only the removal tool needs to be lined up with the knife shaft upon knife installation. This can further be made easier for the operator by effective industrial design, such as by giving images that make sense to be lined up, which capitalizes on the human ability to recognize and match patterns (e.g., lining up similar profile shapes).

The design of the first embodiment protects the unlock ring of the knife removal tool from being actuated, by using an overhang. The unlock ring needs to be shifted/rotated past and below the overhang making defeat of the tool very difficult to achieve manually.

The new tool design has drain holes located near the periphery of the removal tool. These holes are sized so that it would be difficult for an operator to manually engage the knife edge (knife is still protected), but it also allows for particles to escape out the front from the periphery of the tool, radially outward of the knife edge.

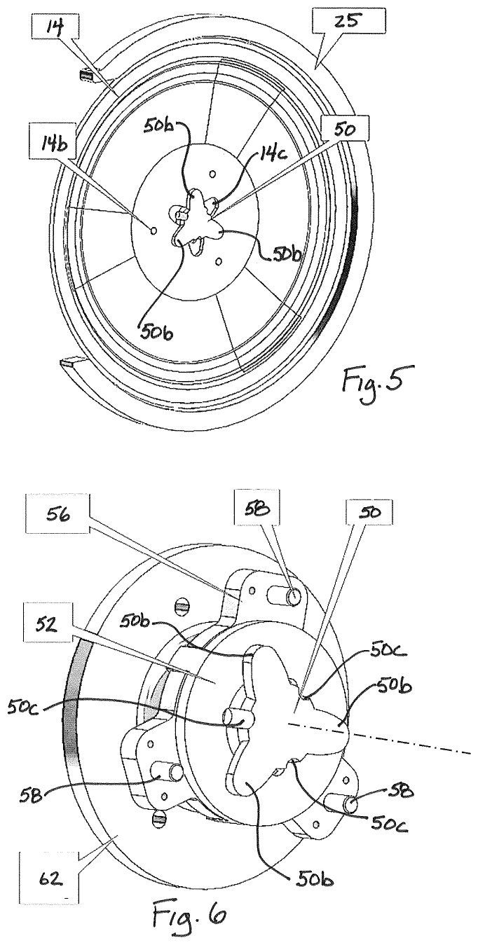

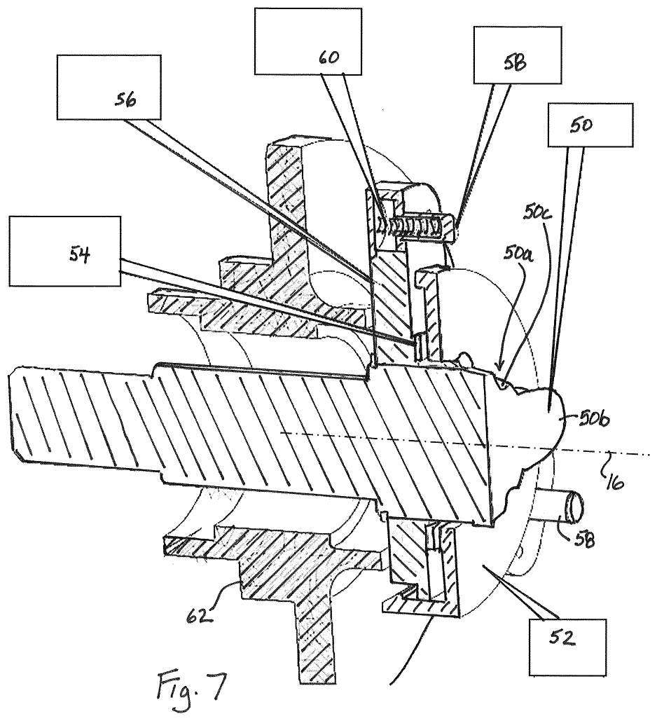

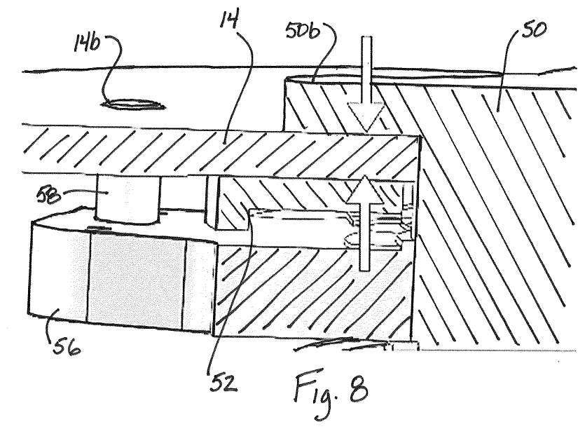

Referring to FIGS. 5-8, the mount system for the slicer knife 14 is shown and includes a drive shaft 50 that defines the rotation axis 16. The drive shaft 50 includes and end portion 50a with three radially projecting lobes 50b. In the illustrated embodiment, three peripheral edge arc recesses 50c are also provided, but variations without recesses 50c are possible. The axial position of the shaft 50, including the end portion 50a, along the axis 16 is fixed. A spring cap 52 is positioned below (axially inwardly of) the end portion 50a and is biased outward toward the underside of the end portion 50a by one or more springs 54 positioned below the spring cap and above a surface portion of a drive pin housing 56. The drive pin housing 56 is fixed so as to rotate with the shaft 50 and does not move axially. The drive pin housing carries a plurality of drive pins 58 that are biased axially outward by springs 60 located in holes or recesses 56a of the drive pin housing. The drive pins 58 engage with corresponding holes 14b in the knife 14 in order to rotate the knife 14 with the shaft 50. A shaft bearing housing 62 is also shown.

As shown, the lobes 50b capture the knife 14 in order to hold the knife axially on the drive shaft, with the spring cap 52 pressing the knife axially outward toward the lobes 50b in a clamping action. This configuration achieves an even axial force against the knife via the spring cap. The knife 14 includes a central opening 14c having a peripheral shape that substantially matches the peripheral shape of the end portion 50a of the drive shaft, such that the knife can be moved axially onto or off of the shaft when the shapes are aligned. As the knife is moved axially onto the drive shaft 50, the spring force of the spring cap 52 and the pins 58 must be overcome (i.e., the knife presses the spring cap 52 and the pins axially inward) until the lobes 50b clear the axially outer side of the opening 14c, enabling relative rotation between the knife 14 and the drive shaft 50 into a position in which the pins 58 engage into the knife holes 14b (i.e., the mount position of FIG. 5). Knife removal requires axial depression of the pins 58 inward and out of the holes 14b so that relative rotation between the knife 14 and the drive shaft 50 is possible to enable the shaft lobes 50b to be aligned with the corresponding lobe shapes of the knife opening 14c, allowing the knife to be moved axially off of the shaft.

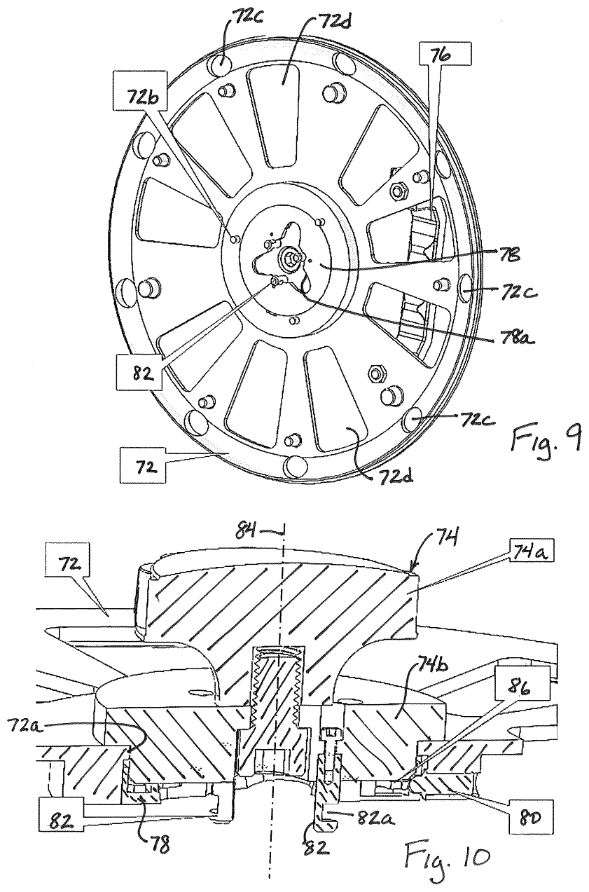

Referring to FIGS. 9-12, a knife removal and installation tool 70 includes a tool base or body 72, a central knob 74, and a handle 76. The central knob 74 is formed by a grip part 74a and base part 74b that mounts into a central opening 72a of the body 72, and is held in place by a capture plate or disc 78 that is fixed thereto. The grip part 74a, base part 74b and capture plate or disc 78 are all interconnected to rotate together relative to the body 72, and such rotation may be between a knife retaining/holding position and a knife release position, which positions can be defined by engagement of a radially inwardly biased knob lock 80 that engages with one opening in the peripheral edge of the capture plate or disc 78 to define the knife retaining/holding position and with another opening in the peripheral edge of the capture plate or disc 78 to define the knife release position. In the illustrated example, the two openings are be offset by about sixty degrees. The capture plate or disc 78 includes a central opening 78a with a shape that corresponds the shape of the central opening 14c of the knife (and the shape of the end portion of the slicer drive shaft).

The base part 74b carries projecting grab pins 82 that have slot portions 82a facing radially outward of a central axis 84 of the knob. Here, these grab pins 82 are axially fixed. When the knob 74 is rotated to the knife retaining/holding position, edge regions 14c1 of the knife opening 14c are engaged into the slot portions 82a such that the knife is retained against the tool body 72 (e.g., with portions of the body protecting the peripheral cutting edge of the knife). When the knob 74 is rotated to the knife release position, the grab pins 82 move into the lobe regions of the knife opening 14c, such that the grab pins 82 no longer retainingly engage the knife, allowing the knife to be released onto the slicer knife mount.

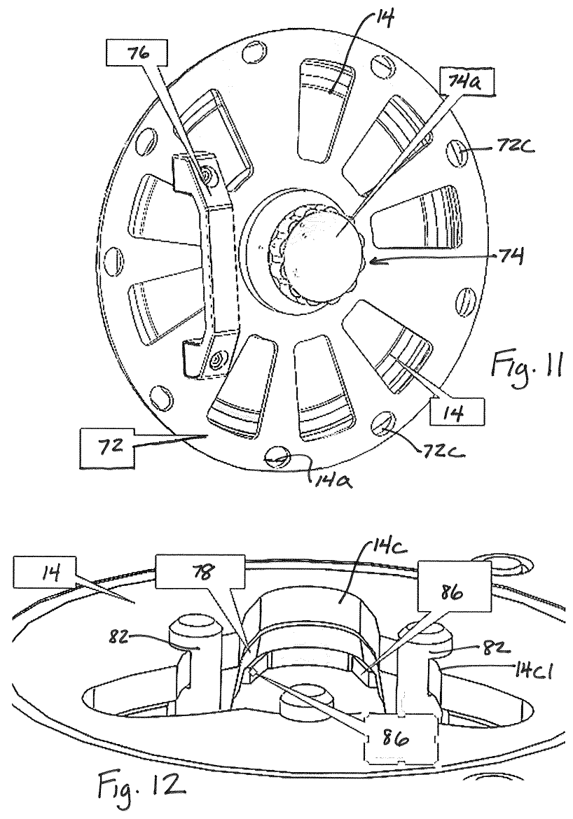

When the knob 74 is in the knife retaining/holding position and engaged with the knife, the knob lock 80 prevents a user from rotating the knob 74 in a manner that would release the knife, unless the tool is being used to mount the knife onto the slicer. In this regard, an unlock ring 86 is captured between the base part 74b and the capture plate or disc 78, and the ring 86 must be rotated relative to the knob lock 80 in order to enable rotation of the knob 74 relative to the body 72. As seen in FIG. 12, the unlock ring 86 is configured such that, in order to reach the position that will release the knob 74 for rotation relative to the body 72, the unlock ring 86 must be rotated underneath an edge portion of the clamping plate or disc 78, which functions as an overhang. This configuration makes it difficult for a user to manually move the unlock ring 86 far enough to release the knife 14, without using some type of tool and significant effort, when the knife removal tool is being used to protect the knife 14 with the knife disengaged from the slicer.

Drain holes 72c are provided in the body 72, in a region near the outer periphery of the body, to facilitate knife cleaning. These holes 72c may provide a very small gap at the knife edge, in limited regions, to allow particles to pass. The body 72 also includes large radial openings 72d, such that alignment features that might be included on the knife surface or part of the slicer can be viewed therethrough. The grip part 74a of the knob is shown as generally round, but its shape could be made to correspond to the lobe shape of the shaft end portion 50a to further aid in intuitive alignment by a user.

### First Embodiment—Knife Removal from Slicer

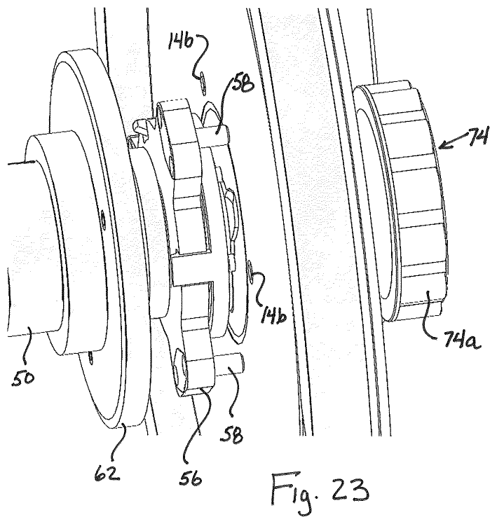

Referring to FIGS. 13-22, the operation of removal of a knife from a slicer is described. Removing the knife from the knife drive shaft involves the following sequence.

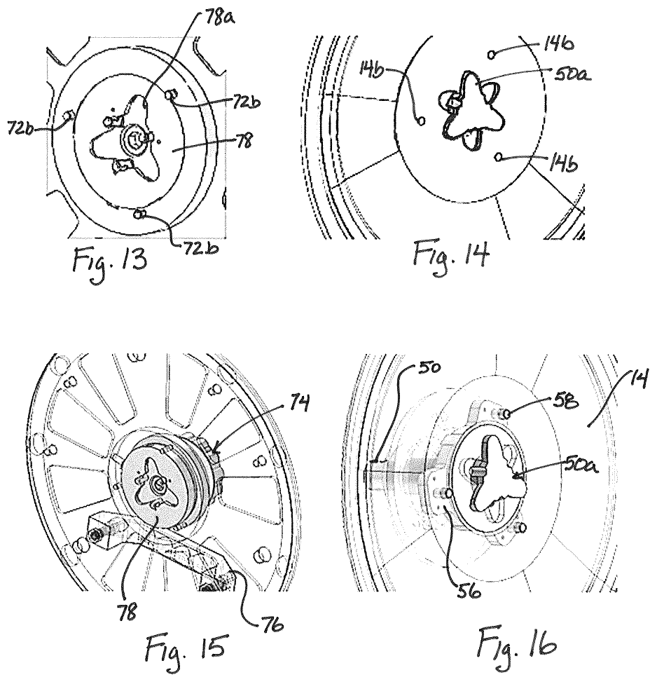

The tool is aligned with the knife drive shaft, as required. The shape of the opening 78a is aligned with the shape of the shaft end portion 50a in this step, which also aligns the unlock pins 72b protruding from the body 72 with the pin holes 14b of the knife 14. See FIGS. 13-14.

Once the removal tool is properly lined up with the knife, the removal tool will be pressed axially into/against the knife 14. The unlock pins 72b on the removal tool will depress the drive pins 58 in the pin holes 14b that prevent relative rotation between the knife and the knife shaft. With the drive pins 58 depressed axially inward beyond the holes 14b, the knife is now free to rotate relative to the knife shaft 50 if the spring friction is overcome (this will generally be done by holding the removal tool handle 76 stationary, which in turn is holding the knife stationary, while rotating the removal tool knob 74 which in turn rotates the knife shaft 50). Holding the removal tool stationary with a handle as opposed to pinning the removal tool against something static/stationary on the machine is advantageous, because it allows for the shaft to be in any rotational position during knife removal. See FIGS. 15-16.

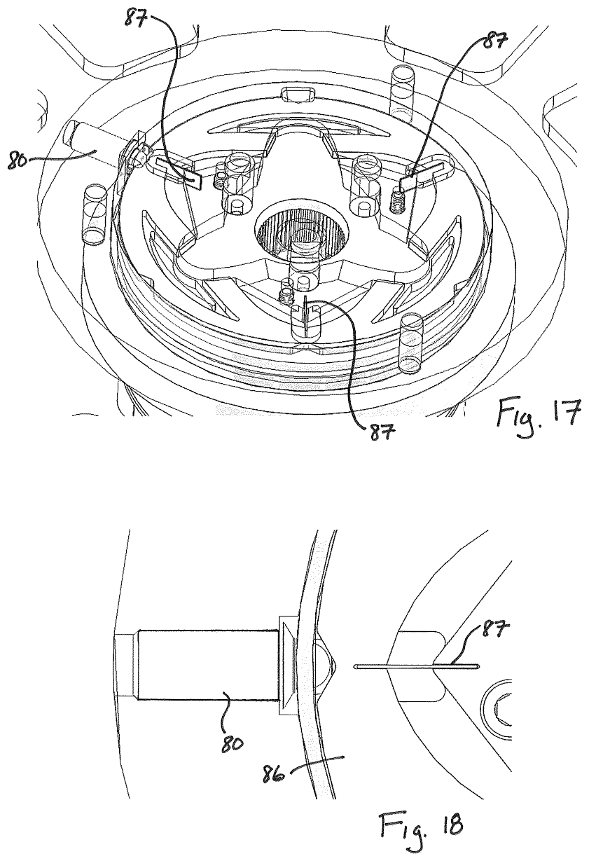

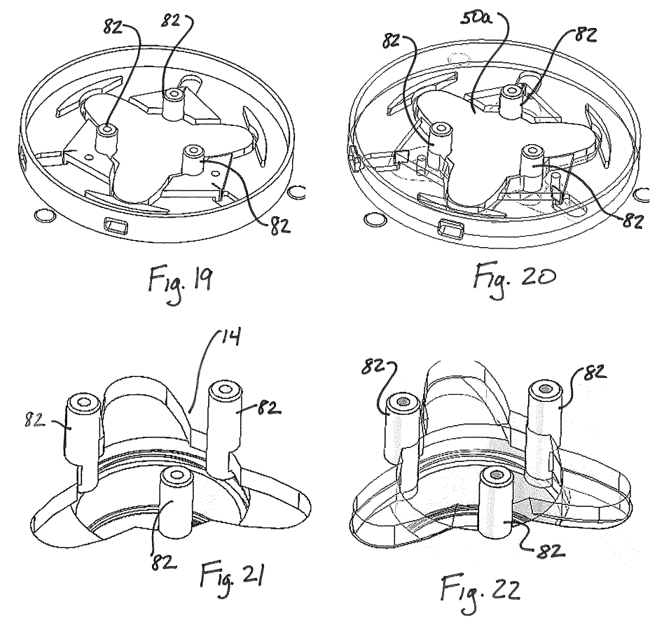

At this point, rotation is not fully unlocked between the removal tool knob and the removal tool housing, but there is some slop to allow for the full unlocking of the mechanism. A spring plunger acts as the knob lock 80 and this is depressed and overridden (or unlocked) by the unlock ring 86. The unlock ring 86 is actuated when the small rotation (allowed by intentional slop) of the removal tool knob 74 allows the knife shaft geometry to rotate the unlock ring 86. The removal tool knob clamp plate 78 has a recess/opening 78a that allows the end portion 50a of the knife shaft to fit inside of it. The unlock ring 86 is protected under an overhang so that the shaft can actuate it, but it is difficult to defeat, accidentally or intentionally, without using a tool. The unlock ring 86 is held in position by flat springs 87 but can rotate in either direction. When the shaft end portion 50a engages the unlock ring 86 and upon rotation overcomes the flat springs 87, the unlock ring 86 will be rotated in a way that depresses the spring plunger (knob lock 80). Once the knob lock is depressed, the removal tool knob 74 and associated clamp plate or disc 78 will be free to spin relative to the removal tool body 72 (which will in turn continue to spin the knife shaft relative to the knife). See FIGS. 17-18.

Once rotation is fully unlocked, the grab pins 82 of the removal tool will rotate the shaft. During this rotation, the grab pins 82 will slide and grab the knife 14. At full rotation, the grab pins 82 will be firmly placed in a position that secures the knife, the shaft end portion 50a will be rotated so that the knife can pass through it, and the removal tool knob 74 will be locked again by the knob lock 80. See FIG. 19-22.

### First Embodiment—Installing the Knife onto the Knife Shaft

The tool with carried knife is aligned to the knife shaft. This involves aligning the peripheral shape of the central opening 14c of the knife with the peripheral shape of the shaft end portion 50a.

Once the removal tool (and attached knife) are lined up with the shaft end portion 50a, the drive pins 58 on the knife shaft will be depressed and the shaft end portion 50a will pass through the knife inner geometry. The main spring 54 will then be overcome (as the removal tool is being pushed axially toward the knife shaft) and the removal knob 74 can then rotate the knife drive shaft 50. The knife shaft 50 has ramps underneath (axially below the lobe portions) to engage and pull the knife 14 down and deflect the spring clip 52 and main spring 54 more easily. See FIG. 23.

Some built-in slop will allow the removal tool knob 74 to rotate enough for the knife shaft end portion 50a to actuate the unlock ring 86 inside the removal tool assembly. This unlocking will allow the removal tool knob 74 to rotate, which in turn will rotate the knife shaft.

As rotation continues, the grab pins 82 will pass back out into free space where they are no longer grabbing the knife 14, the removal tool knob 74 will be locked relative to the main removal tool body 72 again, and the drive pins 58 will engage with the holes 14b on the knife to prevent knife rotation relative to the knife drive shaft.

### Second Embodiment

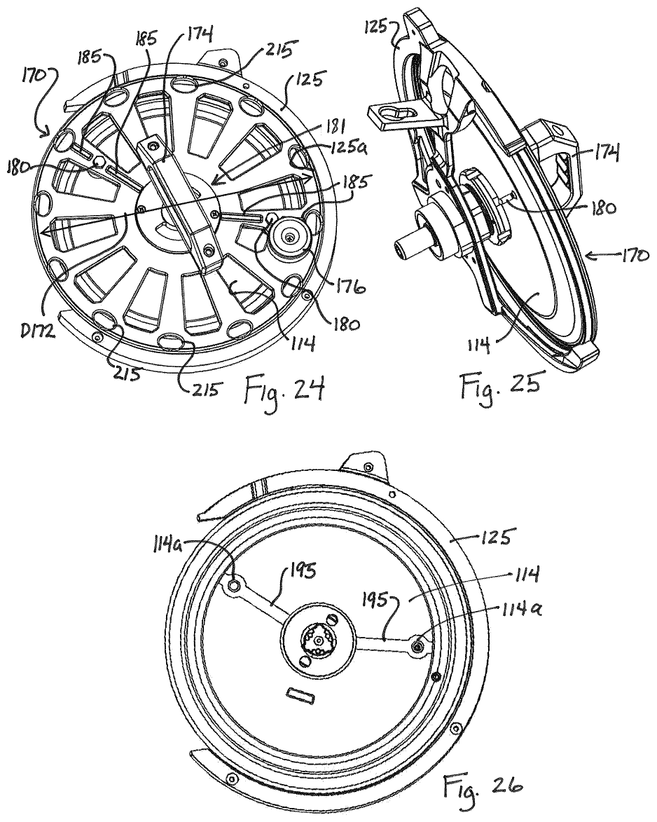

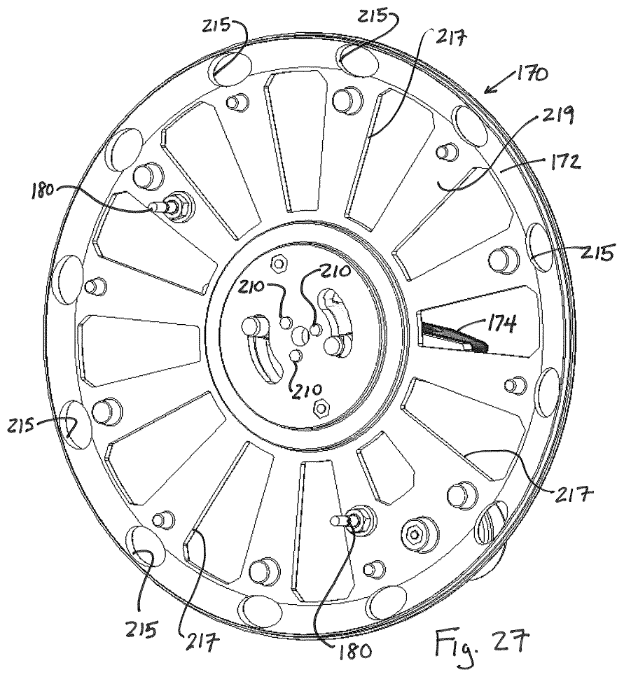

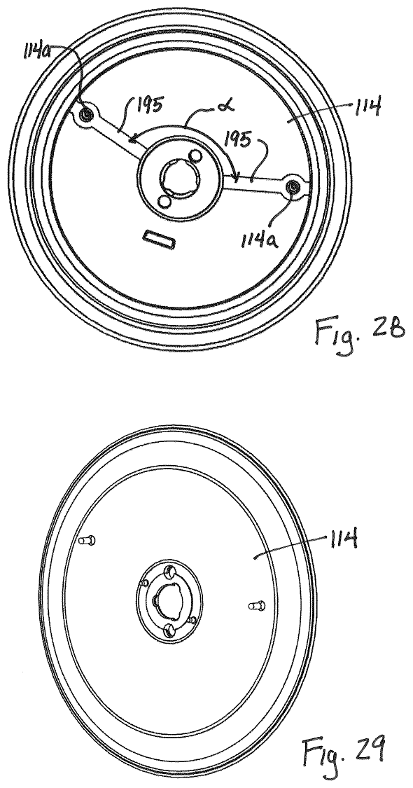

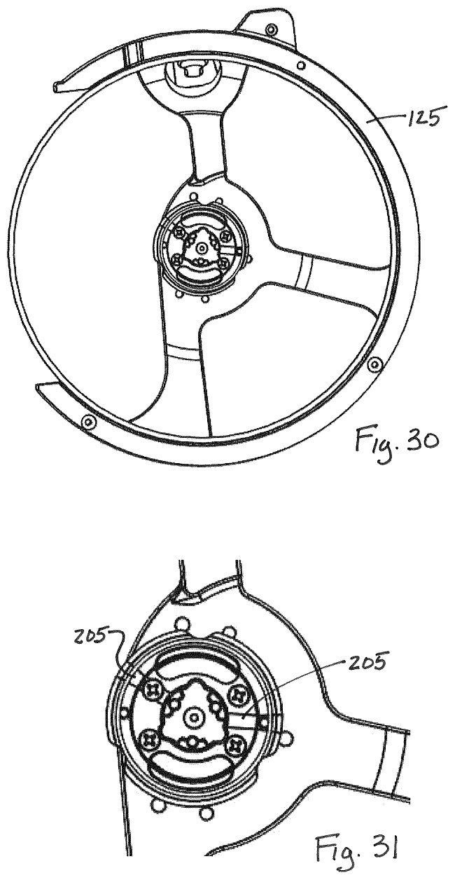

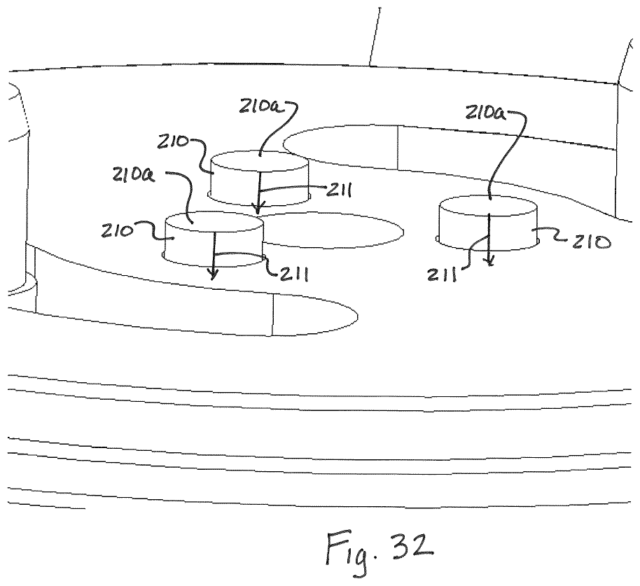

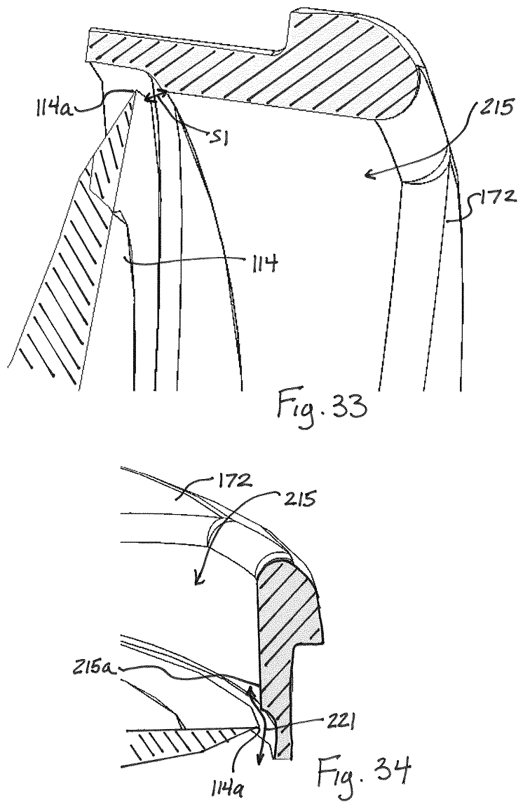

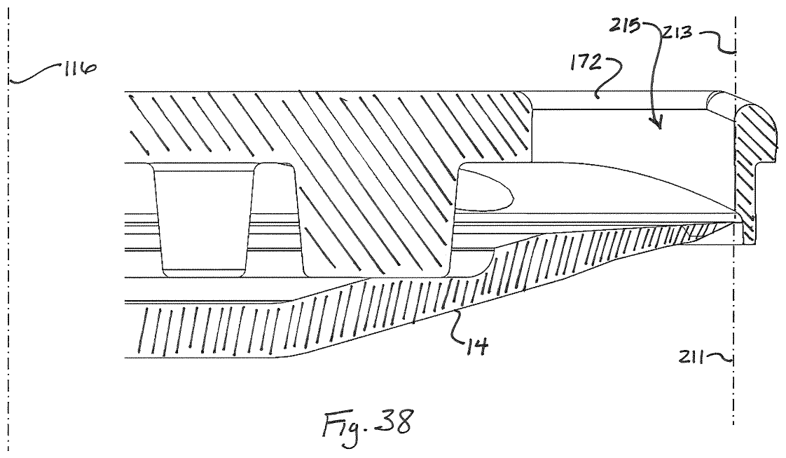

Referring to FIGS. 24-34 and 38, a slicer knife removal tool 170 is shown and includes a tool base or body 172, a central rotatable handle 174, and a stationary handle/knob 176. From a knife removal and installation standpoint, except as otherwise specified below, the central region 181 of the tool 170 is consistent with the teachings in U.S. Pat. No. 8,136,435, which is incorporated herein by reference. Thus, rotation of handle 174 is carried out for the purpose of connecting the tool 170 to knife 114, and releasing the knife 114 from the tool 170 and back onto the knife mount of the slicer.

Here, the tool design removes the need for locating the removal tool on or relative to the ring guard 125. This is achieved by providing the secondary handle/knob 176 that the operator holds to keep the tool body or base 172 stationary while rotating the primary handle 174 to remove or install the knife. In addition, the diameter D172 of the tool body or base 172 is set to be slightly smaller than the diameter defined by the arcuate inner edge surface 125a of the ring guard 125. Thus, there is no overlap between the tool 170 and the ring guard 125 when the knife is being removed from the slicer or installed back onto the slicer.

The removal tool 170 needs to only be lined up with the knife 114 during knife removal and only with the knife mount shaft upon knife installation. This can be further simplified and improved to optimize operator ergonomics. This design accomplishes better ergonomics by making it obvious or intuitive to the user as to how the removal tool needs to line up.

The tool body 170 carries two alignment pins 180 that must align with holes 114a in the knife 114 during engagement of the tool onto the knife 114 for knife removal from the slicer. As previously noted, the removal tool housing or body also nests within the ring guard 125.

Clear and simple visuals/graphics may be provided to facilitate alignment. Here, two straight line patterns 185 are located on the handle side of the knife tool body 172 and each pattern extends radially outward from the center of the knife removal tool, intersecting the location of the alignment pins 180. Likewise, the knife 114 includes two straight line patterns 195 on the outwardly facing side of the knife and that extend radially outward from the center of the knife, intersecting the location of the holes 114a. Further, the mount knife mount structure at the end of the knife drive shaft includes two straight line patterns 205 at the outwardly facing side. All of these patterns are similarly configured so that they can be aligned. In this case, the two straight lines or linear bands 185 of the tool body and the two straight lines or linear bands 195 of the knife are both similarly angularly offset from each other (i.e., they are not in line and parallel with each other). In embodiments, the enclosed angle α formed by each set of the two linear bands 185 or 195 is less than one-hundred seventy degrees (e.g., less than one-hundred sixty degrees, such as between one-hundred forty degrees and one-hundred sixty degrees). The operator can coordinate these graphics to “sight in” the removal tool onto the knife for knife removal, and to site in the knife removal tool (with attached knife) to the knife drive/mount shaft for knife installation. Where the various parts are formed of metal, the line patterns may, for example, be permanently applied by an etching process.

The general reason that this works better than previous designs is because humans are good at recognizing and matching patterns. Further, this type of design communication is effective even without written instructions.

In this case, when the knife is engaged on the knife removal tool, a set of three pins 210 extend from the rear side of the tool and knife combination, and it is axial depression of these pins 210 that enable the knife to be released from the tool. Here, the pins 210 must be axially depressed, per arrows 211, such that the free end surface 210a of each pin is moved inwardly past the external surface of the tool housing/body to unlock the mechanism that allows handle rotation and knife release. This cannot be done manually (e.g., with a person's finger). Therefore, a special tool must be used.

The knife removal tool includes a set of through openings/drain holes 215 distributed around the tool body near the outer periphery of the tool body. These holes 215 are sized so that it would be difficult for an operator to access the knife edge, but it also allows particles to escape out the front from the edges of the tool during cleaning (e.g., water and particles can move off the surface of the knife that faces the tool body and through the holes 215). By way of example, a spacing S1 between the peripheral cutting edge 114a of the knife and the surfaces bounding the through openings/drain holes 215 may be no more than 6 mm (e.g., (e.g., no more than 5 mm, or no more than 4 mm or no more than 3 mm). In embodiments, at least eight (e.g., at least ten or at least twelve) through openings/drain holes 215 are equally spaced apart about the periphery of the tool body 172.

Large radial openings 217 (similar to 72d above) are also provided in the tool body, creating a set of tool body spokes 219 that extend radially outward from the central region of the tool body. Here, the through openings/drain holes 215 are aligned with the spokes 219, and offset from the radial openings 217.

In implementations, the total through area of the combined openings 215 and 219 of the tool body 172 results in exposure of at least 30% (e.g., at least 35% or at least 40% or at least 45% or at least 50%) of the outwardly facing surface side of the slicer knife 114 when the knife is engaged on the knife removal tool, which enhances overall cleaning of the knife when the tool and knife are place in a washing sink or tub or a dishwasher.

In embodiments, the through openings 215 at least partly overlie respective regions of the knife cutting edge 114a, when viewed in an axial direction along a central axis of the tool body 172.

In embodiments, the through openings 215 are positioned and configured such that a radially outer perimeter portion 215a of each opening 215 aligns closely to the radial position of the knife cutting edge 114a. For example, a radial distance from the radially outer perimeter portion 215a (here represented by line 213 running parallel to the central axis 116) and the central axis 116 of the tool body and/or knife may be with 6 mm or less (e.g., 5 mm or less, 4 mm or less or 3 mm or less) of a radial distance from the correspondingly aligned knife cutting edge 114a (here represented by line 211 running parallel to the central axis 116) and the central axis 116 of the tool body and/or knife. The illustrated arrangement provides a clear flow path 221 around the knife cutting edge in this region. Note that the opening bounding tool body surface portion that is aligned with line 213 represents the tool body surface portion that (i) is nearest to the knife cutting edge and (ii) bounds the through opening 215.

The design of Embodiment 2 provides various advantages.

In the described system, the need to align various parts during knife removal and installation is reduced, and the alignment of the parts is intuitive. This means that for the first time, an operator has a chance at figuring out how to remove and install the knife without any written/verbal instructions.

The described system makes it difficult to defeat or handle improperly, reducing the likelihood of inadvertent separation of the knife from the tool body (a tool needs to be used to defeat). To remove the knife from the machine, either the removal tool or a special tool is needed. To remove the knife from the removal tool, either the machine shaft or a special tool is needed.

The combined tool and knife assembly is configured to facilitate cleaning of the front of the knife via inclusion of the drain holes on the front of the tool body, proximate to or near the outer periphery of the tool body.

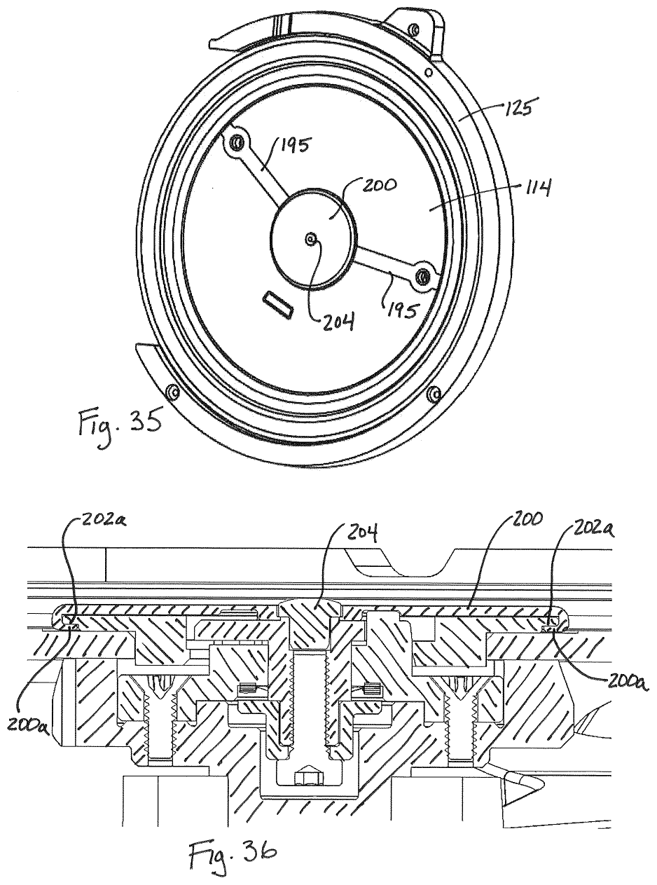

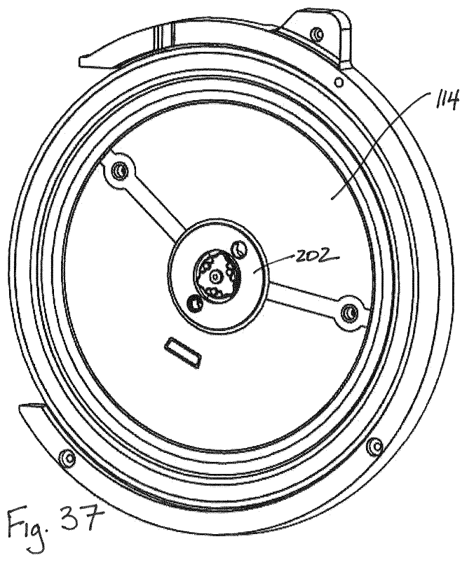

Not all customers desire the advantages provided by a slicer knife removal tool. In prior slicer implementations employing a slicer knife removal tool, for sanitation reasons, it has been necessary to offer one version of the slicer configured to cooperate with the slicer knife removal tool, and another version of the slicer that is not configured to cooperate with the slicer knife removal tool. This increases overall production costs due to the need for different knife mount component structures as between the two designs/versions of the slicer. As seen in FIGS. 35-37, in order to address this problem, in the case of the system described herein, the slicer can be configured with or without a cover 200 that overlies the knife retaining plate 202 that holds the knife on the slicer. The cover 200 can be secured to the slicer via a fastener/plug 204 and/or edge portions 200a of the cover that extend around the knife retaining plate edge and then below the periphery of the knife retaining plate 202. By way of example, the edge portions 200a could operate as snaps that grab an under-hang 202a of the knife retaining plate 202. FIG. 35 shows a slicer configuration in which the cover is included on the slicer (only portions of the slicer shown) and FIG. 37 shows a slicer configuration in which the cover is not includes on the slicer (only portions of the slicer shown). The cover may be a rubber (e.g., nitrile) component or a plastic component. When provided, the cover 200 covers and seals the internal knife retaining components of the slicer.

The use of the cover provides an advantageous method of producing both slicers that are sold with a knife removal tool and slicers that are not sold with a knife removal tool. In both cases, the functional components for use of the knife removal tool are included on the slicer, but those components are covered and sealed by the cover in the case of slicers that are sold without a knife removal tool.

It is to be clearly understood that the above description is intended by way of illustration and example only and is not intended to be taken by way of limitation. Variations are possible.

1. A system, comprising:
a food product slicer including:
a base;
a knife mounted for rotation about an axis relative to the base via a knife drive shaft;
wherein the knife drive shaft includes an end portion that overlaps an externally facing surface portion of the knife to hold the knife, and a biasing mechanism pressing the knife toward an underside of the end portion;
a knife removal tool configured for engaging with the knife drive shaft and the knife so as to remove the knife from the knife drive shaft, wherein the knife removal tool is configured to:
(i) enable removal of the knife from the knife drive shaft irrespective of a rotational position of the knife removal tool relative to any fixed portion of the food product slicer;
or
(ii) enable removal of the knife from the knife drive shaft irrespective of a rotational position of the knife relative to any fixed portion of the food product slicer.

2. The system of claim 1, wherein each of the knife removal tool, the slicer knife and a knife mount structure at the end of the knife drive shaft carries a similarly oriented graphic pattern to facilitate intuitive alignment of (i) the knife removal tool with the knife for the purpose of engaging the knife removal tool with the knife during knife removal and (ii) the knife removal tool with the knife mount structure for the purpose of engaging the knife back onto the slicer during knife installation.

3. The system of claim 1, wherein the knife removal tool carries two pins that must engage into and through two corresponding openings in the knife, wherein the two pins are not diametrically opposed to each other relative to a center axis of the knife removal tool, wherein the two openings of the knife are similarly not diametrically opposed to each other relative to a center axis of the knife.

4. The system of claim 3, wherein each of the knife removal tool and the slicer knife carry a similarly oriented graphic pattern to facilitate intuitive alignment, wherein the graphic pattern of the slicer knife runs through or in alignment with the openings, and wherein the graphic pattern of the knife removal tool runs through or in alignment with locations of the pins.

5. The system of claim 4, wherein the graphic pattern of the slicer knife includes linear bands that run through or in alignment with the openings, and wherein the graphic pattern of the knife removal tool includes linear bands that run through or in alignment with locations of the pins.

6. The system of claim 1, wherein:
the food product slicer includes a ring guard disposed about a portion of the periphery of the knife, wherein the knife removal tool comprises a body that nests inside the ring guard in order to engage with the knife.

7. The system of claim 1, wherein the knife removal tool comprises a body and a handle, wherein the body can rotate around the handle, or the handle can rotate relative to the body.

8. The system of claim 1, wherein the knife removal tool comprises a tool body with an outer peripheral edge, wherein the tool body includes a set of through openings located near the outer peripheral edge and distributed around a periphery defined by the peripheral edge so as to facilitate cleaning of a knife engaged with the tool body, wherein the set of through openings are sized and positioned such that a knife cutting edge is not fully exposed when the knife removal tool is engaged to hold the knife.

9. The system of claim 8, wherein, for each of one or more of the through openings, a spacing between the knife cutting edge and a nearest tool body surface portion bounding each of the one or more through openings is no more than 6 mm.

10. The system of claim 8, wherein the set of through openings at least partly overlie respective regions of the knife cutting edge, when viewed in an axial direction along a central axis of the tool body.

11. The system of claim 8, wherein each through opening of the set of through openings is bounded in part by a covering, solid peripheral edge region of the tool body.

12. The system of claim 1, wherein, when the knife is engaged with the knife removal tool after removal of the knife from the food product slicer, the knife removal tool includes at least one locking component that must be moved to an unlock position to allow a handle of the knife removal tool to rotate and release the slicer knife, wherein the locking component is configured to prevent an operator from moving the locking component to the unlock position without use of a tool.

13. The system of claim 12, wherein the at least one locking component comprises at least one pin that must be axially depressed by a distance that moves an axial end surface of the pin inwardly beyond an external surface surrounding a knife removal tool body opening through which the pin extends.

14. The system of claim 1, wherein the knife removal tool is configured to:
(i) enable removal of the knife from the knife drive shaft irrespective of the rotational position of the knife removal tool relative to any fixed portion of the food product slicer;
and
(ii) enable removal of the knife from the knife drive shaft irrespective of the rotational position of the knife relative to any fixed portion of the food product slicer.

15. A slicer knife system, comprising:
a knife removal tool;
a disc-shaped slicer knife engaged with the knife removal tool;
wherein the knife removal tool includes at least one locking component that must be moved to an unlock position to allow a handle of the knife removal tool to rotate and release the slicer knife, wherein the locking component is configured to prevent an operator from moving the locking component to the unlock position without use of a tool.

16. The slicer knife system of claim 15, wherein the knife removal tool includes a main body, wherein the at least one locking component comprises multiple pins extending outwardly through respective openings in the main body, wherein each pin must be axially depressed by a distance that moves an axial end surface of the pin inwardly beyond an external surface of the main body that surrounds the opening through which the pin extends.

17. A slicer knife removal tool, comprising:
a tool body with an outer peripheral edge, wherein the tool body includes a set of through openings located near the outer peripheral edge and distributed around a periphery defined by the peripheral edge so as to facilitate cleaning of a knife engaged with the tool body;
wherein the set of through openings are sized and positioned such that a knife cutting edge is not fully exposed.

18. The slicer knife removal tool of claim 17, for one or more of the through openings, a spacing between the knife cutting edge and a nearest tool body surface portion bounding each of the one or more through openings is no more than 6 mm.

19. The slicer knife removal tool of claim 17, for one or more of the through openings, a spacing between the knife cutting edge and a nearest tool body surface portion bounding each of the one or more through openings is no more than 5 mm.
